(19) United States
(12) Patent Application Publication
(10) Pub. No.: US 2015/0286381 A1
(43) Pub. Date: Oct. 8, 2015

(54) Mobile device and desktop software program for cataloging objects or events of interest into different channels and chains of automated actions

(71) Applicant: Antoine Nguyen, San Francisco, CA (US)

(72) Inventor: Antoine Nguyen, San Francisco, CA (US)

(21) Appl. No.: 14/176,576

(22) Filed: Apr. 7, 2014

(51) Int. Cl. G06F 3/0484; G06F 3/0482; H04L 29/08; G06F 3/0488; H04L 12/58; G06F 3/0481; G06F 3/0486

(52) U.S. Cl. CPC G06F 3/04847; G06F 3/04817; G06F 3/0482; G06F 3/04842; G06F 3/0486; G06F 3/04883; H04L 51/046; H04L 67/10

(57) ABSTRACT

The software program of the invention helps the user of mobile device or desktop computer to regroup all common user applications and data into one place in such a way the navigation between different tasks or objects of interest becomes simpler and faster (less button clicks or screen touches). Additionally, it helps the user to automate sequences of actions or tasks that can be triggered later via simply a couple of clicks, a timer setup or upon the reception of a message or email. The automated tasks can be triggered both by senders and receivers of email or message.

### BACKGROUND OF THE INVENTION

In the current organization of mobile devices and computers, all the most used elements are organized into separate components: as a result the common user has to navigate in and out of different programs to achieve a set of related tasks, et let alone automate them: For an example, a person who wants to invite a friend to go shopping after receiving a discount coupon will have to:
Open the contact list program to search for the invitee's name then make a phone call via a Phone call icon click then exit the contact list program.
Open the email program to extract the address of the related store from the coupon offered via email then exit the email program.
Open the map and navigation program to search for the location of the store's address copied from the email program.
Open a text editor to save the address of the store into a separate file for later use.

All these actions require a lot of button clicks or screen touches therefore cost a lot of time. Moreover the entailed process can be error prone and forces the user to repeat some of these actions along the way.

It appears that if a software program can regroup all user applications and common data into one place in such a way the navigation between different tasks or objects of interest becomes simpler (less button clicks or screen touches), the software program will help the user to save a tremendous amount of time. Additionally, it would make life easier if the same software program can also record and save the sequences of actions that the user has made so that he can trigger them again later when needed via simply a couple of clicks, a timer setup or upon the reception of a message or email. As a result a new way of task creation or transfer will be faster and simpler.

### SUMMARY OF THE INVENTION

In accordance with the invention, the problem of unnecessary time loss and errors due to long navigations between applications and collection of data in order to perform a set of related tasks is solved by an mobile device or desktop based software program that regroups the user data and associated tasks into a set of channels of objects based on shared purposes or consistent relationships. The software program of the invention allows the user to navigate faster between objects of different channels via as short as two key strokes. When a channel is selected by the user, the software program will display a carousel of objects that belong to the selected channel, the user then can make a button click or screen touch to open a task buttons menu that has a special form of a frame surrounding the object's screen. This special task menu of the invention will allow the user to trigger or create associated tasks of the object immediately. Each object of the invention is defined via an unlimited number of object profiles and each object profile is an association between a specific media type and an associated task attribute. Each object profile is defined via an independent file itself in order to make it behave like a plug-and-play object therefore can be deleted, moved or created without requiring any further modification of other objects of the channel set in order to reflect the initial change. The first immediate benefit of the invention is to create a set of personal television, internet video or radio channels wherein the user can store and view his/her favorite shows per channel, set an alarm for a showtime, send emails, messages (with photo and hyperlink) to alert other peoples about the show. The second immediate benefit is to create a set of channels for common objects of interest or daily tasks wherein each channel represents an event, a subject of interest (people, object, place, cause, etc), an effort or endeavor, etc. A channel of objects of interest can be automatically sent to a predefined receiver (i.e. an automated list of errands to a grocery store). A sequence of daily tasks can be automated then later on triggered via one click or upon a timer setup or upon reception of a special event via email or a special internet connection protocol.

### DETAILED DESCRIPTION OF THE INVENTION

The software program of the invention (hereafter named as “the software program”) consists of:
A main menu (illustrated by FIG. 1) that displays at least a button to access the channel list, a button to access the active channel, a button to capture image, audio or video quickly with the purpose to create objects of interest of the active channel, a button to display the current user's location using the device's provided GPS services, a button to access the list of automated task chains, a button to access the list of alert objects previously trigerred by timer, alarm or received emails and messages, a rectangular frame of channel buttons (illustrated by drawing objects “Channel 1” to “Channel 20” in FIG. 1) that surround the device's screen. The purpose of the main menu is to allow the user to access quickly to most needed daily tasks, objects of interest per channel, alert objects and automated tasks.
The button of channel list when touched or clicked will display a pull-down menu (illustrated by FIG. 2) that presents the channel names of all the existing channels that either came from the software installation package or previously created by the user.
A set of folders which represent each a user predefined channel.
Each channel will have a folder of its own and will be used to store all the system files that represent the objects and their task attributes created along the way by the user.
Each object is defined at least by one task attribute which can be a text based description file, an drawing image or a photo, a video-clip or an audio-clip.
Each task attribute represents a purpose, a task with or without associated external application or a description of the object. Each task attribute can store i.e. GPS based location data, navigation guidance, codebar, Qcode, person contact with phone number, email address, hashtag, website hyperlinks, meeting schedule, interview schedule and contact, flight and hotel reservations, etc.
Each task attribute is represented by a separate file that has the same name as other task attributes of the same object but with a unique file extension based on its purpose so that the software program can categorize them and the user can delete them on the one on one basis without causing further modification of other components of the software program.
Each channel will be displayed via a carousel of objects (illustrated by FIG. 3). Only one object is displayed at a time inside the carousel even if the object may have multiple task attributes. By a simple click on the surface of the object inside the carousel (whether at a specific corner or at the center) (illustrated by drawing frames 1,2,3 and 4 in FIG. 3) the user can see all the associated task attributes of the object.
The task attributes of an object of interest are displayed by means of a rectangular frame based menu of buttons (illustrated by drawing frames “UserApp1”, “UserApp2”, “UserApp3” in FIG. 3) that surrounds the border of the carousel's screen on which the main content of the object is displayed (illustrated by FIG. 3). Each task attribute is represented by a button that has either an associated icon or an associated label.
The user can trigger any external application associated to a task attribute of an object of interest by simply clicking on the exposed button of the task attribute (illustrated by drawing frames “UserApp1”, “UserApp2”, “UserApp3” in FIG. 3); in this case the whole related content of the object is transferred to the related external application via the system clipboard that the external application can use or via a predefined interface of the external application. In the second case, the user can select only a portion of the screen that contains the interested content (text, image, hyperlink, etc) then drag it (using finger or mouse) to any task attribute associated button of the buttons menu in order to trigger the associated external application with the selected content. The software program will transfer the selected content into the system clipboard that the external application can use or via a predefined interface of the external application.
The user can create a new task attribute for the displayed object inside the carousel by dragging (using finger or mouse) any task attribute associated button into any section of the object's screen inside the carousel (illustrated by FIG. 3).
The user can create a separate list of email addresses and associate it to each channel of objects of interest. The user can later select one, some or all items of the email address list when sending email with an object's content in it to the selected email address list. Each email address associated to any channel of objects can be combined with a phone number so that the user can send messages or SMS instead of emails.
The user can create a unique channel identification number for each channel. This channel identification number can be used to make a special channel visible to other users or to provide a means of channel based automatic archiving. The software program will check for this channel identification number when it receives an object of interest via emails or messages from another users; if the channel identification number attached to the email or message exists then the software program will store it into a dedicated folder of this special channel, or reject this very object of interest or simply store it into a shared folder of all common objects. The channel identification number can be declared invalid any time by the user when needed, especially in case of temporary channels. This channel identification number can define a secret key if the user decides to make it available to only a narrow public.
Each channel identification number can be tied to a period of validity (with start date-time and duration). The period of validity has the purpose which is to help the user to limit the reception of objects of interest to a certain period and/or to have a channel and its objects automatically destroyed when the period of validity is passed.
The user can also record a predefined action or task (or sequence of predefined actions or tasks) into a single automated chain of tasks. Each predefined action or task is a combination of object of interest and its associated external application to be executed. After a single automated chain of actions/tasks is made and stored in the file system of the software program, the user can trigger it either manually when needed or via a timer setup or when a predefined event occurs (i.e. reception of a phone call or a message or email). As a result the software program will alert the user and display the list of upcoming actions or tasks with their urgency indicators when needed.

### BRIEF DESCRIPTION OF THE DRAWINGS

FIG. 1:

Illustrating the main menu of the software program for fastest access to channels, objects of interest, alert objects and automated task list.

FIG. 2:

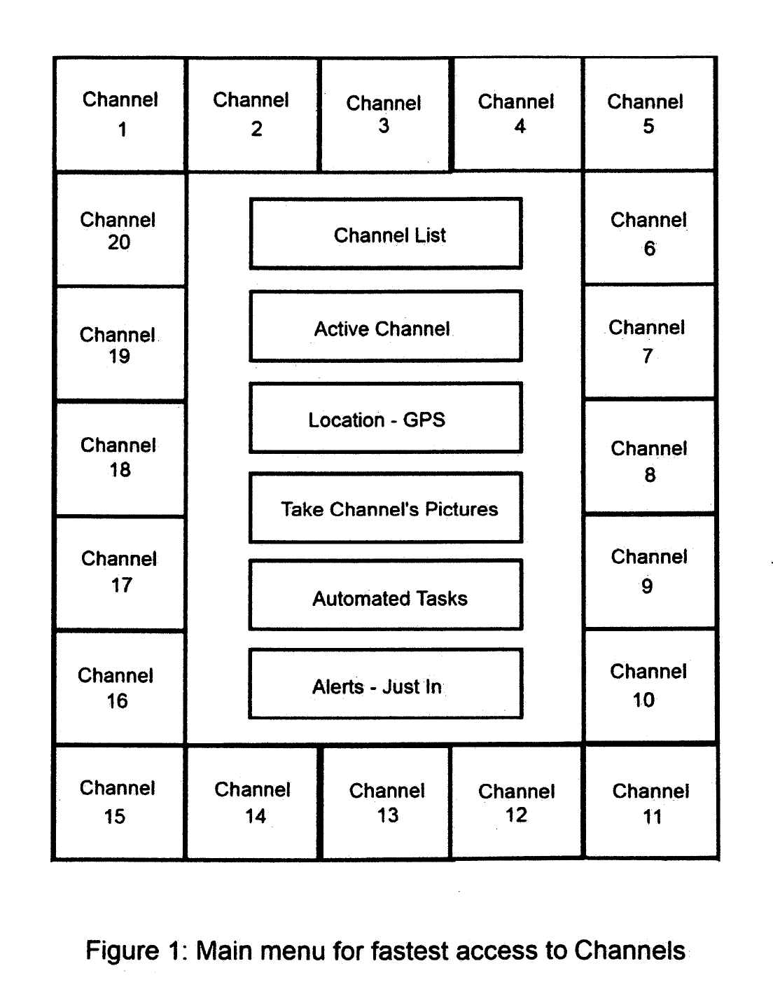

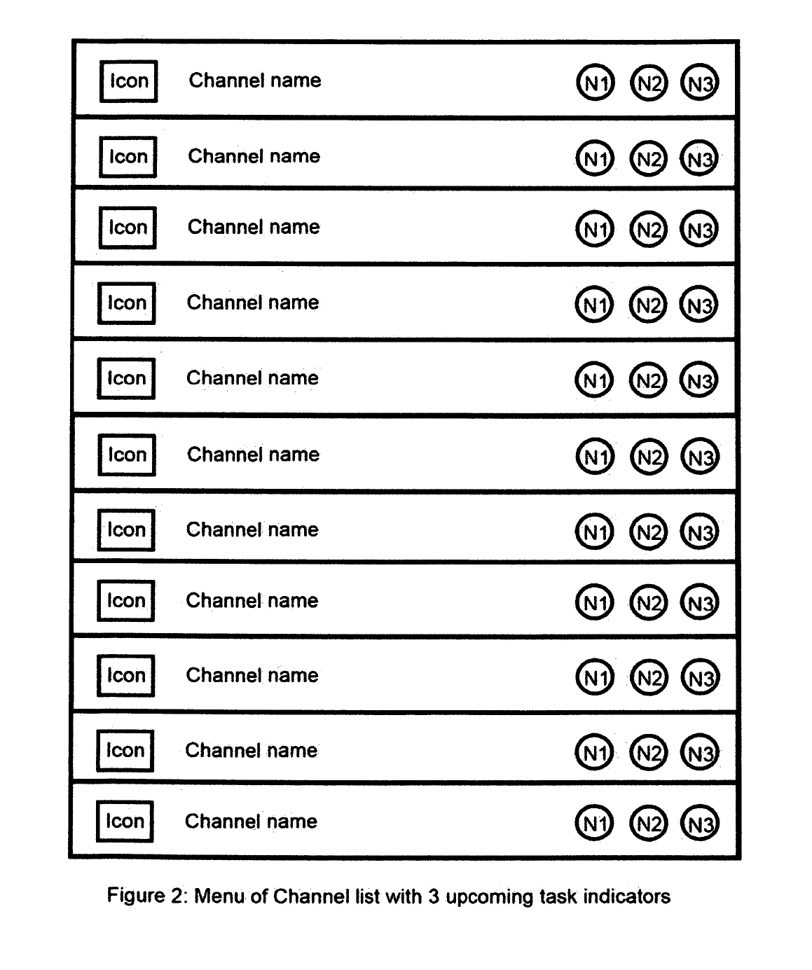

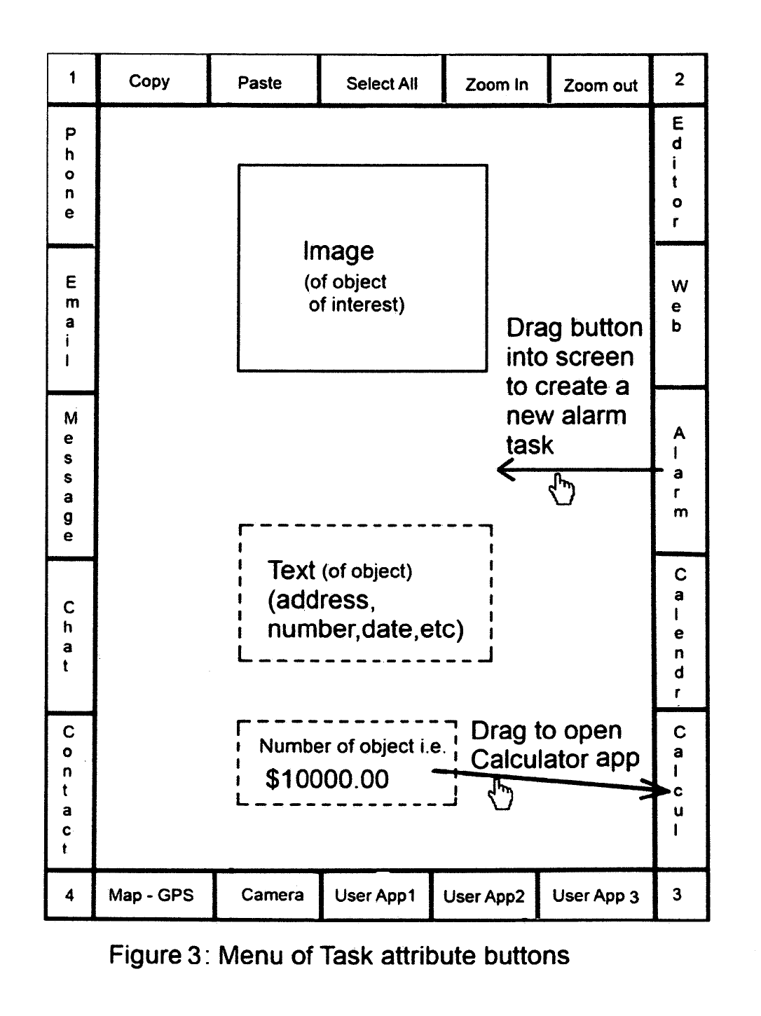

Illustrating the menu of channel list. Each item of the menu contains:
An icon representing the related channel.
The name or title of the related channel which can be i.e. a television channel name or a daily task name (Errands, To-do-list, Parking, Music, Family, Friends, Pets, Cars, Schools, doctors, Interviews, etc).
One green round icon “N1” with a number (inside it) that indicates the current count of upcoming tasks or shows in the non urgent state.
One yellow round icon “N2” with a number (inside it) that indicates the current count of upcoming tasks or shows in the urgent state.
One red round icon “N3” with a number (inside it) that indicates the current count of due tasks or shows for which the deadline has passed.

FIG. 3:

Illustrating the rectangular frame based menu of task attribute buttons upon the device screen that displays an image and text of an object of interest:
All the displayed tasks are samples of common tasks but can be redefined for each user.
All the cornered buttons 1, 2, 3 and 4 can be used to the software program's icon, to show or hide the menu, to scroll the buttons leftwards, to scroll the buttons rightwards.

What is claimed is:

1. A software program that catalogs, for a user of mobile device or desktop computer in which the software program was installed, his or her objects of interest into a set of different channels and a set of automated chains of tasks.

2. The method of claim 1, wherein the user can use the software program to create a channel or set of channels that contain objects of interest such as television shows, radio shows, internet news, books, daily tasks (errands, to-do-list, parking, music, family, friends, pets, cars, schools, work, sport, medicine, news, weather), repeated tasks (paying bills, doctors, interviews, banks, restaurants, flights, hotels), etc.

3. The method of claim 2, wherein each object of interest can be made of different media elements such as image, text, video, audio, GPS coordinates, navigation guidance, hyperlink; each object of interest can be made also of information elements such as email address, barcode, QR code, personal or public contact address and identity profile, schedule, alarm, notice, etc or any possible combination of these media elements and information elements.

4. The method of claim 3, wherein each object of interest can be associated with an unlimited number of tasks and each task is defined by an attribute (called hereafter as task attribute). Each task attribute can stand alone or can be associated with an application stored on the device or with a web browser based application.

5. The method of claim 4, wherein each task attribute is represented by a separate description file that will have the same filename as the object of interest it belongs to in order to allow the software program to move or delete an entire object of interest with all its task attributes quickly and to display each object of interest only once inside the carousel of objects.

6. The method of claim 5, wherein the description file of a task attribute will have a unique file extension per targeted purpose so that any task attribute of a same file extension can be triggered by a same application.

7. The method of claim 4, wherein the description file of a task attribute is a text file that describes the profile of the related task attribute and also the activation mechanism of the associated application.

8. The method of claim 1, wherein each channel can have its own list of contacts containing email address, phone number, fax number, hashtag or any communication identification that the user can edit, store and use them to send objects of interest to the whole or part of the contact list at once.

9. The method of claim 1, wherein each channel can be assigned with a channel identification number. The channel identification number is used to define a unique channel with or without a period of validity. The channel identification number can be made visible to other users via emails or messages using the software program; in this case, the channel identification number of the sender will be included in the subject line or body of emails or messages. The software program of the receiver will use the channel identification number of the sender to reply to the latter via the same means. As a result an object of interest can be filtered both by sender and receiver in order to avoid undesired emails or messages. At reception, the software program will check if the channel identification number attached to a received email or message exists in its database in order to decide whether to accept or reject the object of interest embedded in this email or message. If accepted the received object of interest will be stored in its designated channel's folder without any further need of manual archiving by the receiving user. If the channel identification number contains a period of validity, the software program will have the possibility to reject all emails or messages received beyond the defined period and also to delete the related channel and all its objects of interest if requested by the receiver or the sender. The channel identification number, when included in email or message title, will enable the software program to read only emails or messages that have the content of an object of interest to extract them; as a result non related emails or message remain protected from reading intrusion.

10. The method of claim 4, wherein the menu of all task attributes of an object of interest can be displayed by the software program when the user touches or clicks on the screen of the object of interest and this menu will have the form of a rectangular frame that surrounds the screen. The rectangular frame contains a set of task attribute buttons so that the user can execute a particular task immediately; on button touch or click the software program will automatically execute the application associated with this task attribute and transfer the content of the object of interest to that application by either copying it to the clipboard of the system or via a predefined interface of the associated application.

11. The method of claim 10, wherein the user can also select a portion of the screen where the content of interest is located then drag it (by finger or mouse device) to any task attribute button in order to execute the application associated of the related task attribute. The software program will transfer only the selected content to the associated application via the same method described in the claim 10.

12. The method of claim 10, wherein the user can create a new task for the object of interest displayed on the screen by simply dragging (by screen touch or mouse device) any task attribute button onto the screen where the object of interest is displayed. The software program will generate a separate description file for this new task as defined in the claim 5.

13. The method of claim 3, wherein each media element can be made directly via the software program which uses predefined interfaces with the embedded camera, GPS and other services of the device.

14. The method of claim 2, wherein all the objects of interest of a channel will be displayed through a carousel so that each object of interest can be selected quickly.

15. The method of claim 1, wherein a unique combination (or a sequence of combinations) of objects of interest and their respective tasks can be collected and recorded as a single automated chain of tasks. The single automated chain of tasks can be used to trigger a chain of tasks either manually or on timer based activation by the software program or when the first programmed event is received by the software program.

16. The method of claim 4, wherein any task attribute of any object of interest can be transferred from one device to another while the two users are actively engaged in an internet chat or phone call triggered via the software program, provided that the software program has been previously installed on the two devices and each device knows its counterpart's IP address. The software program can make use of a direct internet connection and a standard file transfer protocol to exchange the related task attribute of the object of interest or the entire object of interest.

17. The method of claim 1, wherein the main menu of the software program displays a button to access the channel list, a button to access the active channel, a button to capture image, audio or video to create objects of interest for the active channel, a button to access to the map of the current user's location using the device's provided GPS services, a button to access the list of automated tasks or chains of tasks previously recorded, a button to access the list of alert objects previously trigerred by timer, alarm or received emails and messages, a rectangular frame of channel buttons that surround the device's screen to access directly the related channels.

18. The method of claim 1, wherein the software program will display the current list of pre-installed or user created channels inside a pull-down menu after the user clicks on the channel list button from the main menu as defined in the claim 17. Each item displayed inside the channel list menu will have for the related channel a representative icon, name or title, one green icon with a number in it to indicate the current count of upcoming tasks or shows in the non urgent state, one yellow icon with a number in it to indicate the current count of upcoming tasks or shows in the urgent state, one red icon with a number in it to indicate the current count of due tasks or shows for which the deadline has passed. The three icons may be replaced simply by the digits with the same color.

19. The method of claim 1, wherein the software program can run on a smartphone, tablet, computer or any mobile device that allow the software program to express all the features that are defined through the claim 1 and all its dependent claims.
